(19) United States
(12) Patent Application Publication
(10) Pub. No.: US 2014/0108029 A1
(43) Pub. Date: Apr. 17, 2014

(54) Matching Mobile Device Enabled Electronic Medical Consultations with Relevant Advertisements and Messages

(71) Applicant: John Sung Kim, Sun Francisco, CA (US)

(72) Inventor: John Sung Kim, Sun Francisco, CA (US)

(21) Appl. No.: 13/838,589

(22) Filed: Mar. 15, 2013

Related U.S. Application Data
(60) Provisional application No. 61/673,119, filed on Jul. 18, 2012.

(51) Int. Cl. G06Q 50/22; G06Q 30/02; G06F 19/00

(52) U.S. Cl. CPC G06Q 50/22; G06F 19/3425; G06Q 30/0246; G06Q 30/0247
USPC 705/2

(57) ABSTRACT

A mobile device implemented method where an electronic medical consultation is matched to advertisements and messages from third parties based on data uploaded by the patient, the patient's mobile device and data from third party applications and hardware running on the patient's mobile device. The level of interactivity from both the patient and the healthcare provider during the and after the electronic medical consultation is recorded in order to improve the relevancy of future advertisements or messages displayed to both patients and healthcare providers.

### INCORPORATION BY REFERENCE

This application claims the benefit of priority under 35 U.S.C. 119(e) to the filing date of U.S. provisional patent application No. 61/673,119 “Matching Mobile Device Enabled Electronic Medical Consultations with Relevant Advertisements” which was filed on Jul. 18.2012, and which is incorporated herein by reference in its entirety.

### FIELD OF THE INVENTION

This present invention relates generally to an automated method of identifying matches via a set of predetermined traits and a set of preference among patients, providers, and advertisements. More specifically, this method can be used to find compatible matches between patients and providers in order to display advertisements that are accurate enough in relevancy for healthcare services; to provide a mobile solution for providers to provide electronic consultation to patients, to provide corresponding advertisement to the patients, to assess the relevancy and accuracy of the advertisement t or message via feedback from both the patients and the providers; and to provide a method for which third parties may be able to better assess and account for the reimbursements of electronic consultations.

### BACKGROUND OF THE INVENTION

Various methods and systems have been developed to connect patients to medical information over the Internet. Often these matching methods and systems are in the context of either the context displayed on the page of the advertisement (such as a banner advertisement) or attempts to predict intentions based on keywords in a search engine (such as a pay-per-click advertisement) or by association in a social network (such as ads from companies one may Like or follow) or by cookies—whereby code is placed on a patient's Internet browser and associated advertisements the patient has viewed before follow them across multiple unrelated websites they may visit in the future.

Such methods and systems are not effective in many healthcare situations because the nature of illness and disease may be more acute, unique and complex. Therefore traditional methods and systems of Internet advertising to patients and their healthcare providers are not efficient or effective at delivering targeted advertisements with a high percentage of accuracy in relevance. For example, many patients and healthcare providers see pharmaceutical advertisements which are not relevant to their condition, sex, age or medical history. We accept this as a common occurrence that men see pharmaceutical ads for women, or vice versa. Yet, since advertisement costs are almost always eventually added to the cost of goods or services sold, this kind of advertisement inefficiency significantly adds to the costs of healthcare for patients and represents a significant problem in many regions and countries.

Healthcare by its nature is episodic and acute, and currently existing methods and systems of Internet advertising for patients work effectively only for situations that are broad and persistent, for example, a patient who purchases shoes will likely have a persistent desire for a broad category of shoes which they will continue to purchase throughout their lifetime; whereas the same patient may only have a skin condition such as cellulitis once in their lifetime and will require a prescribed skin ointment purchase of only once.

This also has relevance for organizations such as health insurance companies, public entities, hospitals and medical provider groups who wish to i) assess the validity of electronic consultations they are reimbursing for and ii) deliver health and wellness messages that are targeted to the contents of the electronic consultations.

A system and method to match advertisements to patients and healthcare providers through the data of an electronic medical consultation as conducted on a mobile device would allow such organizations to more effectively monitor for fraudulent activity such as automated electronic consultations that are artificially generated by a software program or unauthentic patients.

It would also allow such organizations to be able to display advertisements such as their logo or corporate messages, notifications about upcoming services or changes to privacy policies and terms and conditions, reminder or re-care messages, as well as health and wellness messages that are targeted and specific to the patient's condition.

The need for electronic consultations to create a more efficient healthcare economy is widely recognized, but factors such as potential fraud, lack of automated ways to qualify the contents of such consultations as well as a lack of a method or system that allows advertisers and third party organizations to reimburse or subsidize such consultations have prevented such services from gaining in mainstream use.

Therefore there is a need to provide an efficient manner in which organizations can display increasingly relevant advertisements and messages to both patients and healthcare providers in a manner that allows organizations reimbursing for such electronic consultations to prevent fraud, track usage and constrain the types of electronic consultations they will reimburse for.

As such, the invention disclosed herein provide a system and method to automatically collect, analyze, and identify data to provide matches among providers, patients while they are on their mobile devices, and advertisements or messages via a set of predetermined traits and a set of preferences, and consistently improve the accuracy of the relevancy of the advertisement or message through feedbacks from the targeted patients as well as the doctors.

### OBJECTIVE OF THE INVENTION

Accordingly, it is an object of this invention to provide a method and system for matching mobile-device based communications between patients and doctors with relevant advertisements.

It is also an object of the invention to provide organizations reimbursing for electronic consultations to identify the types of electronic consultations they may or may not reimburse for.

It is also the object of the invention to provide a way to match and score electronic consultations to reimbursement eligibility requirements defined by the payer organization.

It is also an object of the invention to provide organizations reimbursing for electronic consultations to identify fraudulent electronic consultation activity.

It is also an object of this invention to provide a cost-effective mobile IT solution to facilitate secure and effective communications and interaction between patients and doctors on their mobile devices.

It is also an object of this invention to provide an environment to efficiently and effectively reimburse doctors for such medical interactions with their patients in a secure and confidential manner.

It is also an object of this invention to facilitate matching advertisement from third party organizations such as public institutions, healthcare provider organizations, pharmaceutical companies, and medical equipment vendors to patients or doctors in cost-effective ways.

It is also an object of this invention to connect service providers, patients, and advertisers via a set of predetermine values and preferences based on patient uploaded data and mobile device data.

It is also an object of this invention to collect patient uploaded data such as medical history, health profile, medical complaints, employment history, healthcare provider specialty requested, insurance type and status, etc. so that the information contain in an electronic consultation has as much data as possible for the healthcare provider.

It is also an object of this invention to collect mobile device data such as texts, audios, images, videos, and geographic locations.

It is also an object of this invention to collect data from diagnostic devices or software applications communicating with mobile device such as Electronic Medical Records or Electronic Health Records.

It is also an object of this invention to encrypt personally identifying information to prevent such information from being available to unauthorized persons.

It is also an object of this invention to provide a un-encryption key to the patient to reveal, retrieve and share personally identifiable information within the patient profile with other providers.

It is also an object of this invention to add descriptive labels to these data sets to function as markers to match advertisements to both patients and providers.

It is also an object of this invention to consistently improve accuracy in relevancy of the advertisements served to both patients and providers.

It is also an object of the invention to measure the level of patient interaction with the advertisement.

It is also an object of the invention to measure the healthcare provider's feedback rating of the advertisement's relevance to the electronic consultation.

It is also an object of the invention to provide advertisers with relevant information to target its advertising to relevant patients.

It is also an object of the invention to reduce the cost of communication and electronic consultations between patients and doctors.

It is also an object of the invention to effectively and efficiently reimburse healthcare providers for communication or electronic consultation sessions with patients.

It is also an object of the invention to reduce the cost of medical goods and services for the patient through reduces costs passed through from the advertisers.

It is also an object of the invention to allow patients to opt into having their data scanned, uploaded and analyzed to be matched to advertisements and messages, and to track these permissions.

### SUMMARY OF THE INVENTION

The present invention discloses a system to host a doctor patient interaction platform for users comprising a network; a host computer; wherein the host computer is connected to the network wherein the host computer provides a interaction platform for one or more users to interact for the purpose of providing healthcare consultation wherein the users are comprised of at least one patient user, at least one healthcare provider user, and at least one third party advertisement provider, an electronic consultation module allowing the healthcare provider user to consult the patient user, an advertisement matching module wherein the advertisement matching module matches advertisements provided by the third party advertisement provider to the healthcare provider user and the patient user. In one embodiment, the doctor patient interaction platform is further comprised of a patient user profile database comprising the patient user's profile, a healthcare provider user profile database comprising the healthcare provider user's profile, and an advertisement profile database comprising the advertisements' profile.

In one embodiment, the patient user's profile is comprised of the patient user's attributes, wherein the healthcare provider user's profile is comprised of the healthcare provider user's attributes, and wherein the advertisements' profile is comprised of the advertisements' attributes.

In one embodiment, the advertisement matching module matches the advertisements to the healthcare provider user and the patient user based on the relevance of the advertisements' attributes to the patient user's attributes and to the healthcare provider user's attributes. In one embodiment, the system further comprising a feed back module wherein the healthcare provider user and the patient user provide feedback regarding the advertisement matching module's match.

In one embodiment, the system further comprising an analysis module wherein the analysis module analyze the interactivity of the patient user and the advertisements.

In one embodiment, the system further comprising a match score module wherein the match score module reports a match score for the advertisement matching module's match base on the feed back module and the analysis module.

In one embodiment, the doctor patient interaction platform generates revenue from the third party advertisement provider.

In one embodiment, the electronic consultation module is comprised of an instant messaging feature allowing the patient user to instant chat with the healthcare provider user. In one embodiment, the doctor patient system is accessed from mobile computing devices of the patient user and the healthcare provider user.

In one embodiment, the doctor patient interaction platform is further installed in mobile computing devices of the patient user and the healthcare provider user.

In one embodiment, an organization providing the reimbursements for electronic consultations relies on the advertisement matching module in order to determine the eligibility of electronic consultations for reimbursement.

In one embodiment, an organization providing the reimbursements for electronic visits on the doctor patient interaction platform define which types of electronic visits can be reimbursed based on the advertisement profiles created.

In another aspect of the invention, a system to host a doctor patient interaction platform is disclosed for users comprising a network; a host computer; wherein the host computer is connected to the network wherein the host computer provides a interaction platform for one or more users to interact for the purpose of providing healthcare consultation wherein the users are comprised of at least one patient user, at least one healthcare provider user, and at least one third party advertisement provider, a doctor patient matching module to match the patient user to the healthcare provide user, an electronic consultation module allowing the healthcare provider user to consult the patient user, an advertisement matching module wherein the advertisement matching module matches advertisements provided by the third party advertisement provider to the healthcare provider user and the patient user.

In one embodiment, the doctor patient interaction platform is further comprised of a patient user profile database comprising the patient user's profile, a healthcare provider user profile database comprising the healthcare provider user's profile, and an advertisement profile database comprising the advertisements' profile. In another embodiment, the patient user's profile is comprised of the patient user's attributes, wherein the healthcare provider user's profile is comprised of the healthcare provider user's attributes, and the advertisements' profile is comprised of the advertisements' attributes.

In one embodiment, the advertisement matching module matches the advertisements to the healthcare provider user and to the patient user based on the relevance of the advertisements' attributes to the patient user's attributes and to the healthcare provider user's attributes.

In one embodiment, the doctor patient matching module match the patient user to the healthcare provide user based on the patient user's attribute and the healthcare provider user's attribute. In one embodiment, the system further comprising a feed back module wherein the healthcare provider user and the patient user provide feedback regarding the advertisement matching module's match.

In one embodiment, the system further comprising an analysis module wherein the analysis module analyze the interactivity of the patient user and the advertisements.

In one embodiment, the system further comprising a match score module wherein the match score module reports a match score for the advertisement matching module's match base on the feed back module and the analysis module.

In one embodiment, the doctor patient interaction platform generates revenue from the third party advertisement provider.

In one embodiment, the electronic consultation module is comprised of an instant messaging feature allowing the patient user to instant chat with the healthcare provider user. In one embodiment, the system is accessible by the mobile computing devices of the patient user and the healthcare provider user.

### BRIEF DESCRIPTION OF THE DRAWINGS

These and other features and advantages of the invention will not be described with reference to the drawings of certain preferred embodiments, which are intended to illustrate and not to limit the invention, and in which:

FIG. 1 is a schematic drawing illustrating an overall flowchart of the method and system of matching patients with providers and providing relevant advertisement.

FIG. 2 is a schematic drawing illustrating a flowchart summarizing the relationship and connectivity of the devices involved.

FIG. 3 is a schematic drawing illustrating the connectivity of multiple patients with the system and method.

FIG. 4 is a schematic drawing illustrating the server, wherein the server hosts the server software and the databases.

FIG. 5A, 5B, 5C are drawings of an embodiment of the present invention embedded on a smartphone.

FIG. 6 is a drawing of another embodiment of the present invention embedded on a smartphone.

### DETAIL DESCRIPTION OF THE INVENTION

The present invention is a system and method for collecting, analyzing, and identifying patient profile, provider profile and advertisement profile to match patients with doctors and to further match relevant advertisement to patients and doctors via a of predetermined traits and a set of preferences. More specifically, the system and method is implemented through the installation of an application or “app” on a mobile device, preferably a smartphone, tablet computer or portable device that has either communications hardware e.g. GPS antennae or computational hardware e.g. CPU. The system and method may also be implemented through visiting of web pages that are rendered on mobile devices such as those mobile devices with Internet browsers.

In one embodiment, the software application can be run on a mobile device having computing power via download and installation from sources such as Google's Android Google Play Store, Apple's iTune App Store, Microsoft Windows Phone Apps+Games Store, etc. The software application, once installed and running on the mobile device, or accessed as a web page from the mobile device's Internet browser, allows its user to input data into a patient profile. In particular, the patient profile is a collection of data for a patient including, but not limited to patient input data, forms, responses to questionnaires, mobile device data, third party software application data, third party hardware data, and data from Electronic Health Records or Electronic Medical Records.

The patient input data is information that the patient has manually entered into the software application running on the mobile device. This data may include, but is not limited to: medication history, health profile, medical complaints, employment history, healthcare provider specialty requested, past medications, past and current diseases or illnesses, insurance type and status, etc.

The mobile device data is information that are taken from various hardware in the mobile device including but not limited to the accelerometer, geo-location antennae, altimeter, compass, images and video from the camera, audio from the microphone, and sensory input from the mobile device's touch screen. The mobile data may include, but is not limited to text, audio, images, video, payment information such as credit cards or insurance identifications, and geographic location. Third party software application data may include information such as facial recognition software or photo-based heart beat monitoring software. As more software applications or apps are developed and made available, more information obtained by these apps will be available for collecting and analyzing. Third party hardware data may include any information provided by any hardware attached to or communicating wirelessly with the mobile device such as a digital stethoscope or a blood glucose meter. Similarly, as more hardware are made to be compatible and work in conjunction with mobile devices, more information will be obtain via these new hardware and be collected and analyzed.

After the collection of the patient profile data, this data is encrypted and then stored in a patient profile database. The data is encrypted to ensure the confidentiality of any personally identifiable information. An un-encryption key, however, is provided to the patient to reveal, retrieve and share personally identifiable information within the patient profile with other providers. The server software then matches the patient profile to a provider from the provider profile database, wherein the provider will respond to the patient's electronic consultation request.

Provider profile, on the other hand, is a collection of data connected to and provided by the provider. The provide profile includes information such as specialty type, age, gender, geo-location, education, license type and status, residency, hospital affiliations, insurance affiliations, group provider affiliations, reviews and ratings from Patients, and the total number of external content and hyperlinks on third party web pages that mention the Provider. The server software then collects these data and adds descriptive markers to the provider profiles.

In one aspect, the markers are labels or tags function to match patient profile to a provider via a set of predetermined traits and preferences. In this context, patients seeking to find a provider can be matched based on the relevance indicated by the markers. In another aspect, the markers are labels or tags function to match advertisement to patient and or provider via a set of predetermined traits and preferences. In one embodiment, the advertisements are delivered to the patients and the providers during their interaction (the electronic consultation, or also known as eVisits). In another embodiment, the advertisements are delivered to the patients when patients are not interacting with the providers. In another embodiment, the advertisements are delivered to the providers when patients are not interacting with the providers. In one embodiment, an advertisement is a message from a health insurance group, a medial services provider, a billing service, a public agency subsidizing the costs of such electronic consultations, or a media company displaying messages on the behalf of itself or its customers.

In one preferred embodiment, markers are text based and are associated with, but not limited to the following: strings of text keywords, images, file types, healthcare complaints, physical characteristics, healthcare histories, pre-existing conditions, ICD medical codes, insurance billing codes, histories of medications, histories of hospitalizations and surgeries, healthcare provider specialists requested, Provider specialties, Patient reviews, hyper-links, hospital affiliations, professional society affiliations, educational institution affiliations, Provider group affiliations, insurance plan affiliations, employer or company affiliations, and geo-location data that would appear in Patient Profiles and Provider Profiles. Each marker has a corresponding number from 1 to 100 that indicates the level of importance of the marker. The scores, however, can be consistently adjusted manually, through automated software, or through third parties. In one aspect, the server software matches the markers in the patients with the markers in the providers so as to allow the matching of relevant providers to patients. In another aspect, the server software matches the markers in the advertisement profiles with similar markers in the patient profile and providers profiles. In such a way, the patient and providers will be matched with more relevant and targeted advertisements.

In one embodiment, the server software will match the markers in the advertisement profile to the markers in the patient profile and automatically select the most relevant advertisements to be displayed to patients according to their electronic consultation. Once the Advertisement Profile has been matched to a Patient Profile, the Patient is shown a media file (the advertisement) related to the Advertisement Profile. Patient is asked at end of advertisement if they would like to be sent additional information on the product or service, which may be in the form of: emails, text messages, messages from within a software application running on the mobile device, or a notification to the Provider that the Patient is interested in discussing the product or service in the matched Advertisement Profile.

The advertisement is also evaluated for accuracy of relevancy as it is matched and served to the patient and doctor. The evaluation is carried out through patient's level of interaction with the advertisement and through provider's rating. Patient's level of interaction with the advertisement is reported as part of the match score. The higher the level of interaction of the patient with the displayed advertisement, the higher the accuracy of relevancy of the advertisement, and vice versa. The provider may also be displayed another media file related to an advertisement profile, wherein its markers are matched to the markers in a provider profile before, during, or after the electronic consultation.

In a preferred embodiment, match score, as mentioned above, are calculated by measuring both the level of interactivity patients have with the media file associated with the advertisement profile and by also measuring surveys from providers rating the accuracy of the relevancy of the displayed advertisement profiles with the electronic consultation.

Advertiser is sent data on information such as the number of matched advertisements displayed, Markers created and matched, level of Patient interaction with the advertisement, times and locations of displayed advertisements, the accuracy ratings (Match Score) of those matched advertisements to Patients and Providers, Provider information and Patient Profile information with personally identifiable Patient information encrypted or removed. Furthermore, because advertisers are able to access patient information to send relevant and targeted advertising, it will reduce the cost of advertising. This in turn will reduce the cost of communication between doctors and patients, because doctors can be reimbursed for such medical consultations. This will also then allow organizations reimbursing for the services rendered in an electronic consultation to limit the types of electronic consultations they are willing to reimburse for, reduce fraudulent electronic consultations, and to provide health and wellness messages to the patient that are targeted with increasing efficiency and accuracy. Finally, reduced costs for advertisers and reimbursing organizations will result in reduced costs of medical goods and services for patients.

In another aspect of the invention, a system and method is disclosed to provide a secure mobile platform for patient to interact with existing providers wherein the platform delivers highly relevant healthcare advertisement to patients and or providers by collecting, analyzing, and identifying patient profile and provide profile via a set of predetermined traits and a set of preferences. The revenue generated by the healthcare advertisement is used to fund the logistic provider for the platform. Providers or patients alike can give feedback as to how relevant the healthcare advertisements are. The interaction between the advertisement and the patients is also taken into consideration to determine the relevancy of the healthcare advertisement.

Again, the system and method is implemented through the installation of an application or “app” on a mobile device of the patients and the providers, preferably a smartphone, tablet computer or portable device that has either communications hardware e.g. GPS antennae or computational hardware e.g. CPU or through accessing a web page on the mobile device's Internet browser.

In another embodiment, the system and method is implemented through the installation of software on desktop computers of the patients and providers.

As stated earlier, the patient profile can be a collection of data for a patient including, but not limited to patient input data, mobile device data, third party software application data, third party hardware data, and data from Electronic Health Records or Electronic Medical Records.

The patient input data is information that the patient has manually entered into the software application running on the mobile device. The mobile device data is information that is taken from various hardware in the mobile device including but not limited to the accelerometer, geo-location antennae, altimeter, compass, images and video from the camera, audio from the microphone, and sensory input from the mobile device's touch screen. The mobile data may include, but is not limited to text, audio, images, video, and geographic location. Third party software application data may include information such as facial recognition software or photo-based heart beat monitoring software.

After the collection of the patient profile data, this data is encrypted and then stored in a patient profile database. The data is encrypted to ensure the confidentiality of any personally identifiable information. An un-encryption key, however, is provided to the patient to reveal, retrieve and share personally identifiable information within the patient profile with existing providers.

Provider profile can be a collection of data connected to and provided by the provider which includes information such as specialty type, age, gender, geo-location, education, license type and status, residency, hospital affiliations, insurance affiliations, group provider affiliations, reviews and ratings from Patients, and the total number of external content and hyperlinks on third party web pages that mention the Provider. Other relevant attributes for provider's profile can also be used as a marker.

In exemplary embodiments, markers are text based and are associated with, but not limited to the following: strings of text keywords, images, file types, healthcare complaints, physical characteristics, healthcare histories, pre-existing conditions, ICD medical codes, insurance billing codes, histories of medications, histories of hospitalizations and surgeries, healthcare provider specialists requested, Provider specialties, Patient reviews, hyper-links, hospital affiliations, professional society affiliations, educational institution affiliations, Provider group affiliations, insurance plan affiliations, employer or company affiliations, and geo-location data that would appear in Patient Profiles and Provider Profiles. Each marker has a corresponding number from 1 to 100 that indicates the level of importance of the marker. The scores, however, can be consistently adjusted manually, through automated software, or through third parties. The server software matches the markers in the advertisement profiles with similar markers in the patient profile and providers profiles. Highly relevant and targeted advertisements can be matched onto the patient and or the providers.

Advertiser is sent data on information such as the number of matched advertisements displayed, Markers created and matched, level of Patient interaction with the advertisement, times and locations of displayed advertisements, the accuracy ratings of those matched advertisements to Patients and Providers, Provider information and Patient Profile information with personally identifiable Patient information encrypted or removed. Furthermore, because advertisers are able to access patient information to send relevant and targeted advertising, it will reduce the cost of advertising. This saving in turn will fund for the logistic provider to continue to provide a platform for patients to interact with the providers in a secure and yet mobile manner. In one embodiment, an advertisement is a message from a health insurance group, a medial services provider, a billing service, a public agency subsidizing the costs of such electronic consultations, or a media company displaying messages on the behalf of itself or its customers. In this context, the advertisements from advertisers that would be matched to eVisits (electronic consultations) and such advertisers would also include large organizations such as health insurance companies or even hospitals displaying wellness ads, even their logo.

### DETAIL DESCRIPTION OF THE DRAWINGS

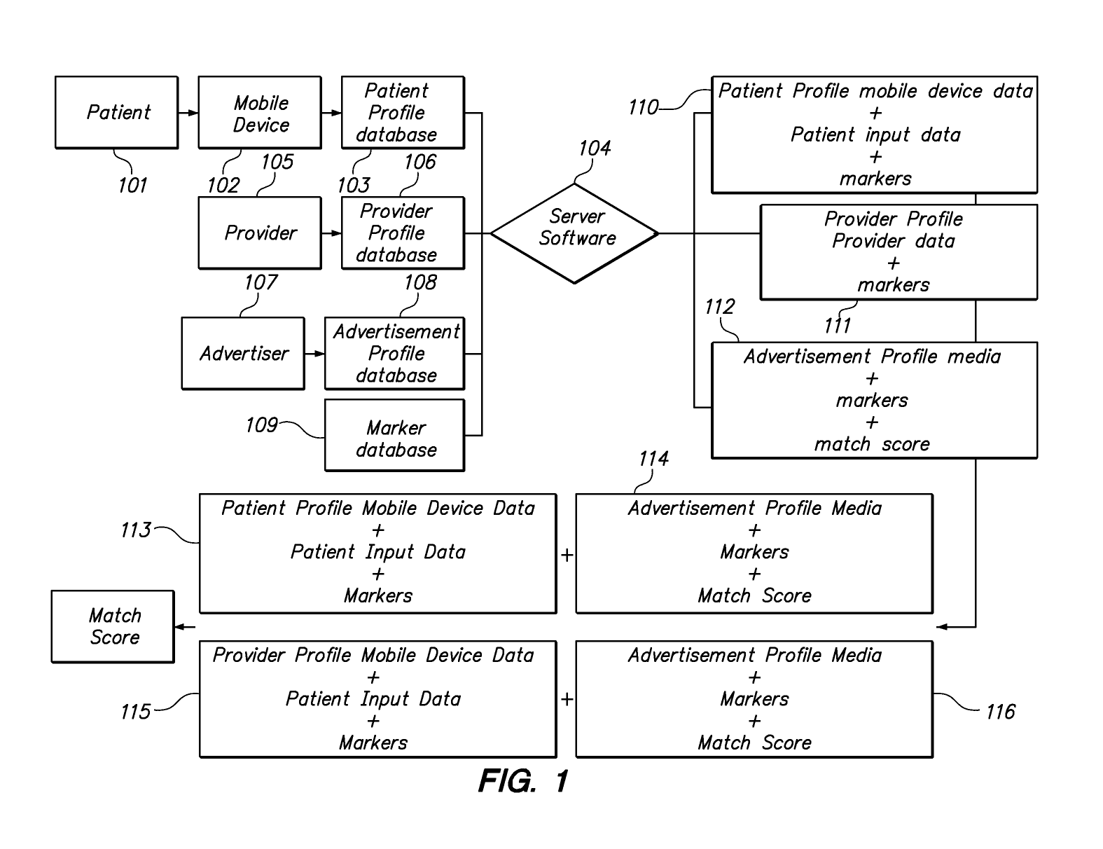

FIG. 1 is a schematic drawing illustrating an overall flowchart of the method and system of matching patients with providers and providing relevant advertisement. More specifically, the patient 100 inputs self-assessed data into software application running on a mobile device or on a web page access from the mobile device's Internet browser 101, wherein the data include medical history, employment history, medical complaints and symptoms, desired providers types, and payment methods, etc. The mobile device 101 records the data from hardware and software attached to or communicating with the mobile device 101, wherein the data may include information from images, accelerometer data, geo-location, audio, video, etc. These data are further added to the patient input data, encrypted to protect personal identifying information, and stored on the patient profile database 103. The server software 104 then tags or labels the patient profile data with markers to enable matching the patient profile with a provider profile and an advertisement profile. In another embodiment where the system provides for a platform of electronic consultation between patients and known providers, the server software 104 matches the advertisement profile with the patient profile and or the provider profile.

Likewise, the providers 105 create provider profiles by inputting data such as specialty, education, geography, insurance or health plan affiliations, hours available for electronic consultations, fees desired per consultation, reviews, mentions on third party web pages, license type, gender, age, and images. This data is stored in the provider profile database 106, wherein the software 104 then tags and labels the provider profile data with markers to enable matching with the patient profile and advertisement profile.

Again, the advertisers 107 create an advertisement profile to display on patients and provider's mobile device or computer. The advertisers 107 can select and create markers connected to each advertisement profile, wherein each advertisement profile has an associated medial file to display. The server 104 uses these markers provided by the advertisers 107 and stored in the advertisement profile database 108 to matching the advertisements to the targeted patient 101 or provider 105.

Markers are descriptive labels to attach to patient profile, provider profile, and advertisement profile data. The markers are stored in the markers database 109, wherein the server software 104 may access it to be used to search for, filter, and match patient profiles and provider profiles to advertisement profiles by server software 104.

The server software 104 is an application that runs in connection with the patient profile database, the provider database, advertisement database, and a markers database. The server software 104 adds markers from the markers database 109 to patient profile and provider profiles, matching patient profiles to available provider from the provider profile database 106, and match patient profile and provider profile with advertisement profiles that have matching markers. After the server software 106 runs, the patient profile is matched to a provider profile to respond to the electronic visit and has markers added to patient profile as shown in 110. Likewise, the provider profile is matched to a patient profile and has markers added to the provider profile as shown in 111. Similarly, the advertisement profile has an associated media file, markers, and a match score as shown in 112. As a result, the patient profiles 113 are matched to the advertisement profiles 114, and the provider profiles 115 are matched to the advertisement profiles 116. Ultimately, the patient and the provider are shown media related to advertisement profiles, wherein the media is displayed to the patient's and the provider's mobile device or computer. Furthermore, the patients are evaluated based on their interactivity with the advertisement, and providers respond to the relevancy of the advertisement. These responses are collected, analyzed, and reported as the match score 117.

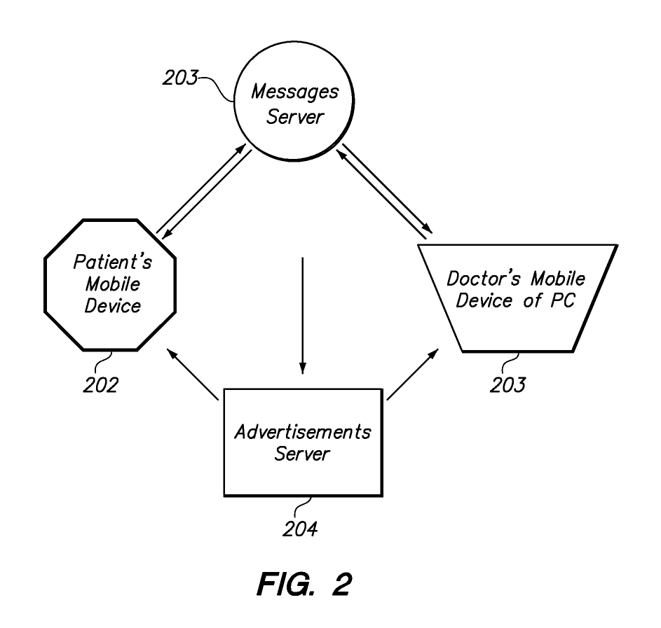

FIG. 2 is a schematic drawing illustrating a flowchart summarizing the relationship and connectivity of the devices involved. The patient's mobile device 201 can send and receive messages via the messages server 202 with the doctor's mobile device or personal computer 203. Furthermore, through the markers obtained from the communication and electronic consultation between the patient and the doctor, the advertiser can target patients and doctors with relevant advertisements sent via its advertisement server 204.

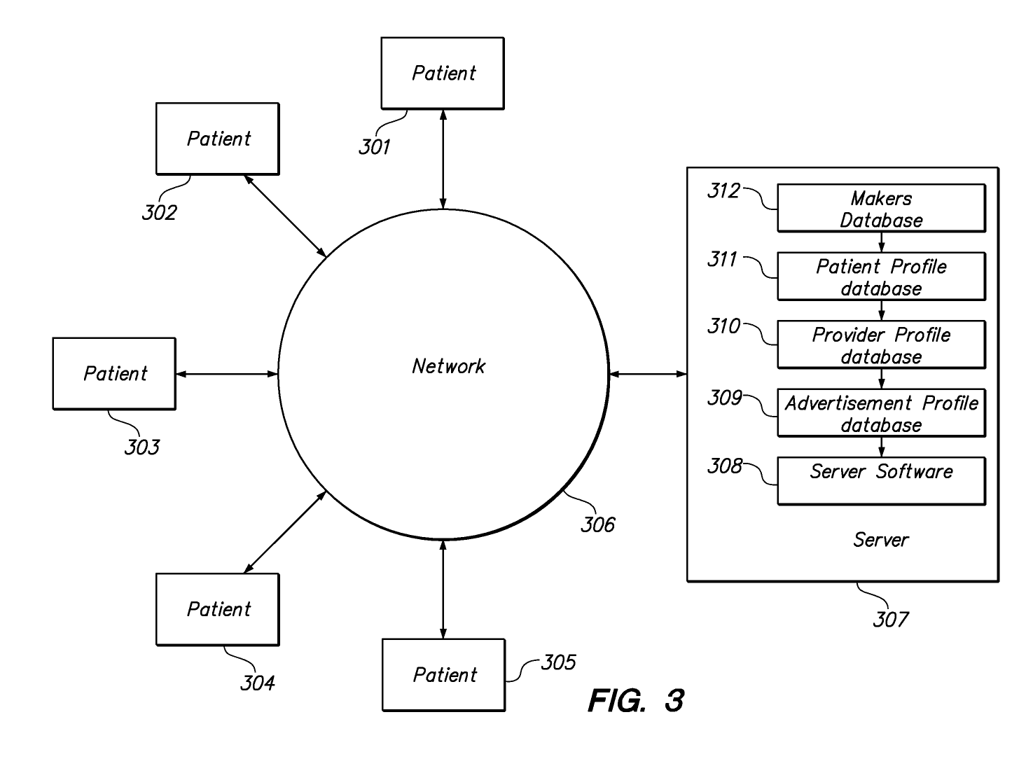

FIG. 3 is a schematic drawing illustrating the connectivity of multiple patients with the system and method. More specifically, multiple patients 301, 302, 303, 304, 305 are connected to the network 306 and thus to server 307, wherein the server 307 contains a server software 308 capable of collecting and analyzing the data of multiple patients 301, 302, 303, 304, 305. The server 307 is further made up of a advertisement profile database 309, providers profile database 310, a patient profile database 311, and a markers database 312.

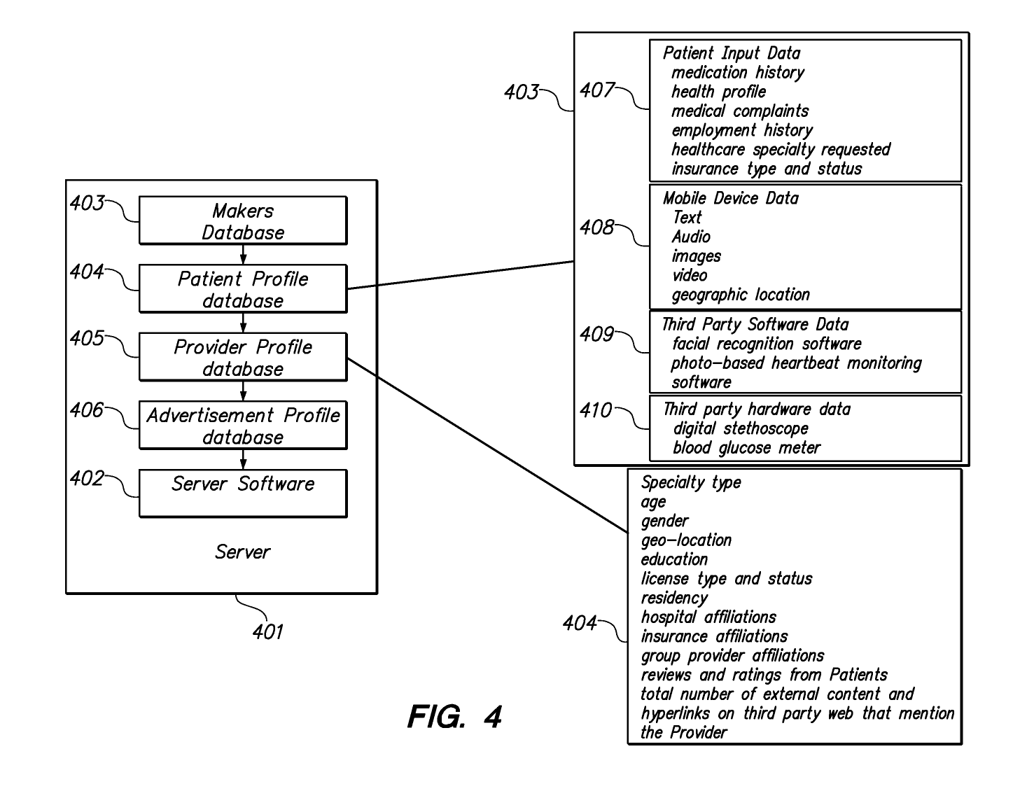

FIG. 4 is a schematic drawing illustrating the server 401, wherein the server 401 hosts the server software 402 and the databases 403, 404, 405, 406. The server contains four categories of database: (1) markers database 403, (2) patient profile database 404, (3) provider profile database 405, (4) advertisement profile database 406.

The markers database 403 contains labels or tags created by advertisers and associated with: strings of text keywords, images, file types, healthcare complaints, physical characteristics, healthcare histories, pre-existing conditions, ICD medical codes, insurance billing codes, histories of medications, histories of hospitalizations and surgeries, healthcare provider specialists requested, Provider specialties, Patient reviews, hyper-links, hospital affiliations, professional society affiliations, educational institution affiliations, provider group affiliations, insurance plan affiliations, employer or company affiliations, and geo-location data that would appear in Patient Profiles and Provider Profiles. Each marker has a corresponding number from 1 to 100 that indicates the level of importance of the marker, whose score can be consistently adjusted by human beings, automated software, or third parties. The server software 402 matches Markers in Advertisement Profiles with similar Markers in Patient Profiles and Provider Profiles.

The patient profile database 404 contains subgroups of data: patient input data 407, mobile device data 408, third party software data 409, and third party hardware data 410. Examples of patient input data 407 includes, but is not limited to, medication history, health profile, medical complaints, employment history, healthcare specialty requested, insurance type and status. Examples of mobile device data 408 includes, but is not limited to, text, audio, images, video, and geographic location. Examples of third party software data 409 includes, but does not include, facial recognition software, photo-based heartbeat monitoring software. Examples of third party hardware data 410 includes, but is not limited, digital stethoscope and blood glucose meter.

The provider profile database 405 contains various data such as specialty type, age, gender, geo-location, education, license type and status, residency, hospital affiliations, insurance affiliations, group provider affiliations, reviews and ratings from Patients, total number of external content and hyperlinks on third party web that mention the Provider.

The advertisement profile database 406 also contains media files that are associated with markers, wherein the markers are used to match relevant advertisement with targeted patients and providers. The targeted patient's level of interactivity with the advertisement and the doctor's rating of the accuracy of the relevancy of the advertisement will be used by the server software 402 to calculate the match scores, which indicates how relevant the advertisements are to the patients and doctors in a particular electronic consultation.

Finally, Advertiser is sent data on the number of matched advertisements displayed, Markers created and matched, level of patient interaction with the advertisement, times and locations of displayed advertisements, the accuracy ratings (match Score) of those matched advertisements to patients and providers, provider information and patient profile information with personally identifiable patient information encrypted or removed.

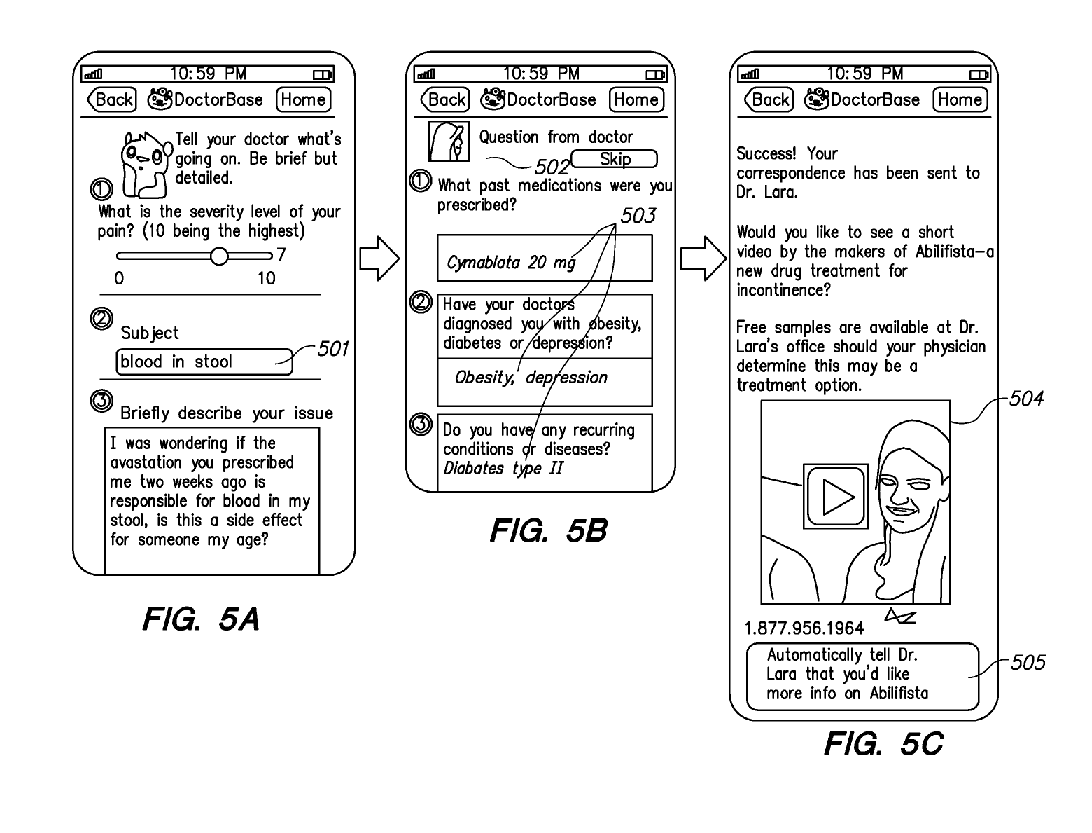

FIG. 5A, 5B, 5C are drawings of an embodiment of the present invention embedded on a smartphone. Specifically, 5A shows the embodiment of the present invention wherein a platform is provided as an application on the smartphone for the patients to interact with the doctors. In this illustration, patients can enter text, audio, video files and or images related to a medical complaint on their mobile device. 501 In FIG. 5B, in the same platform for electronic visitation, doctors can post structured questions 502 asking patient to enter data such as past medication, symptoms, disease or other data 503 that can be easily marked for advertisement matching. In FIG. 5C, the drawing illustrates the platform for electronic consultation where after the patient and the doctor consulted a matched relevant advertisement 504 is displayed to the patient. Patient is given the option to tap on the button 505 and can request for more information in the advertisement 504 to be notified to the healthcare provider.

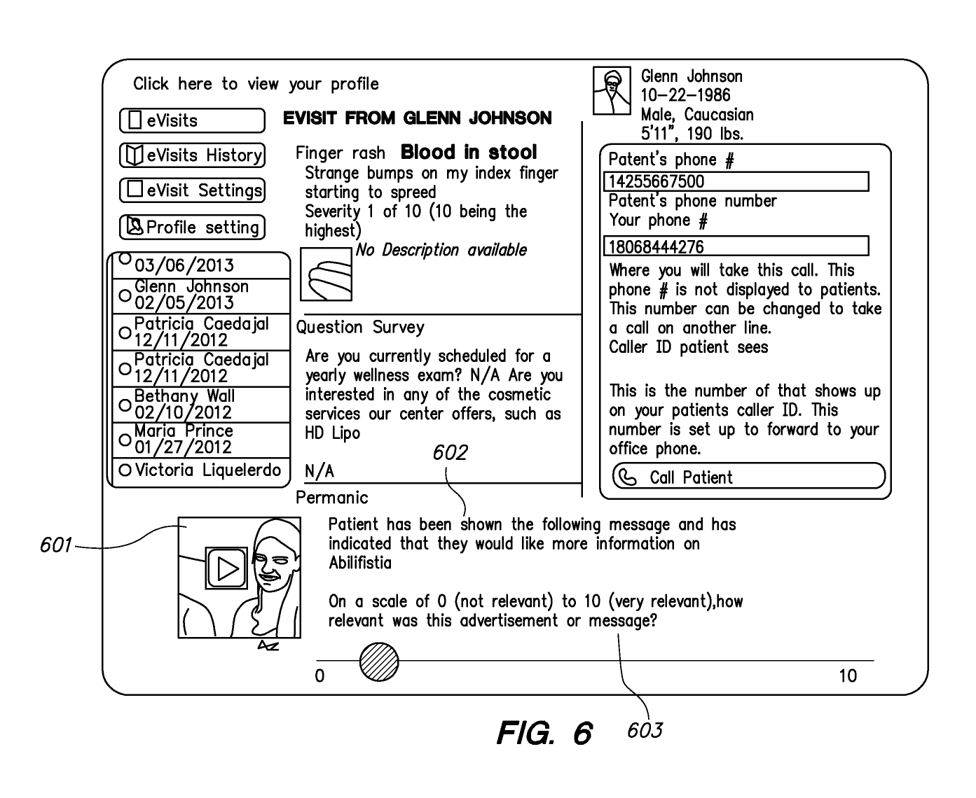

FIG. 6 is a drawing of another embodiment of the present invention embedded on a smartphone. In this embodiment, after the patient tap on the button 505 to request for more information regarding the advertisement 504, the healthcare provider will receive a message 602 regarding the particular advertisement 504 the patient requested information on. In addition, the doctor will also be provided with a copy of the advertisement or message 601 which was displayed to the patient that caused the patient to request for more information. And at the bottom is a scaling system 603 for the healthcare provider to rank the relevancy of the advertisement or message to the profile of either the patient or the healthcare provider.

1. A system to host a doctor patient interaction platform for users comprising a network; a host computer; wherein said host computer is connected to said network wherein said host computer provides a interaction platform for one or more users to interact for the purpose of providing healthcare consultation wherein said users are comprised of at least one patient user, at least one healthcare provider user, and at least one third party advertisement provider, an electronic consultation module allowing said healthcare provider user to consult said patient user, an advertisement matching module wherein said advertisement matching module matches advertisements provided by said third party advertisement provider to said healthcare provider user and said patient user.

2. System of claim 1 wherein said doctor patient interaction platform is further comprised of a patient user profile database comprising said patient user's profile, a healthcare provider user profile database comprising said healthcare provider user's profile, and an advertisement profile database comprising said advertisements' profile.

3. System of claim 2 wherein said patient user's profile is comprised of said patient user's attributes, wherein said healthcare provider user's profile is comprised of said healthcare provider user's attributes, and wherein said advertisements' profile is comprised of said advertisements' attributes.

4. System of claim 3 wherein said advertisement matching module matches said advertisements to said healthcare provider user and said patient user based on the relevance of said advertisements' attributes to said patient user's attributes and to said healthcare provider user's attributes.

5. System of claim 1 further comprising a feed back module wherein said healthcare provider user and said patient user provide feedback regarding said advertisement matching module's match.

6. System of claim 5 further comprising an analysis module wherein said analysis module analyze the interactivity of said patient user and said advertisements.

7. System of claim 6 further comprising a match score module wherein said match score module reports a match score for said advertisement matching module's match base on said feed back module and said analysis module.

8. System of claim 1 wherein said doctor patient interaction platform generates revenue from said third party advertisement provider.

9. System of claim 1 wherein electronic consultation module is comprised of an instant messaging feature allowing said patient user to instant chat with said healthcare provider user.

10. System of claim 1 wherein said doctor patient system is accessed from mobile computing devices of said patient user and said healthcare provider user.

11. System of claim 1 wherein said doctor patient interaction platform is further installed in mobile computing devices of said patient user and said healthcare provider user.

12. A system to host a doctor patient interaction platform for users comprising a network; a host computer; wherein said host computer is connected to said network wherein said host computer provides a interaction platform for one or more users to interact for the purpose of providing healthcare consultation wherein said users are comprised of at least one patient user, at least one healthcare provider user, and at least one third party advertisement provider, a doctor patient matching module to match said patient user to said healthcare provide user, an electronic consultation module allowing said healthcare provider user to consult said patient user, an advertisement matching module wherein said advertisement matching module matches advertisements provided by said third party advertisement provider to said healthcare provider user and said patient user.

13. System of claim 12 wherein said doctor patient interaction platform is further comprised of a patient user profile database comprising said patient user's profile, a healthcare provider user profile database comprising said healthcare provider user's profile, and an advertisement profile database comprising said advertisements' profile.

14. System of claim 12 wherein said patient user's profile is comprised of said patient user's attributes, wherein said healthcare provider user's profile is comprised of said healthcare provider user's attributes, and said advertisements' profile is comprised of said advertisements' attributes.

15. System of claim 12 wherein said advertisement matching module matches said advertisements to said healthcare provider user and to said patient user based on the relevance of said advertisements' attributes to said patient user's attributes and to said healthcare provider user's attributes.

16. System of claim 12 wherein said doctor patient matching module match said patient user to said healthcare provide user based on said patient user's attribute and said healthcare provider user's attribute.

17. System of claim 12 further comprising a feed back module wherein said healthcare provider user and said patient user provide feedback regarding said advertisement matching module's match.

18. System of claim 17 further comprising an analysis module wherein said analysis module analyze the interactivity of said patient user and said advertisements.

19. System of claim 18 further comprising a match score module wherein said match score module reports a match score for said advertisement matching module's match base on said feed back module and said analysis module.

20. System of claim 12 wherein said doctor patient interaction platform generates revenue from said third party advertisement provider.

21. System of claim 12 wherein said electronic consultation module is comprised of an instant messaging feature allowing said patient user to instant chat with said healthcare provider user.

22. System of claim 12 wherein said system is accessible by said mobile computing devices of said patient user and said healthcare provider user.
